(19) United States
(12) Patent Application Publication
(10) Pub. No.: US 2014/0109215 A1
(43) Pub. Date: Apr. 17, 2014

(54) COMPUTER DEVICE CAPABLE OF LOCKING SCREEN AND THE SCREEN LOCKING METHOD THEREOF

(71) Applicant: WISTRON CORP., New Taipei City (TW)

(72) Inventor: BIN JIANG, NEW TAIPEI CITY (TW)

(73) Assignee: WISTRON CORP., NEW TAIPEI CITY (TW)

(21) Appl. No.: 13/791,997

(22) Filed: Mar. 9, 2013

(30) Foreign Application Priority Data
Oct. 12, 2012 (CN) 201210387275.6

(51) Int. Cl. G06F 21/84

(52) U.S. Cl. CPC G06F 21/84
USPC 726/16

(57) ABSTRACT

A computer device capable of locking screen, including a display unit and a processing unit, is illustrated. The display unit is used for displaying one of a locking interface and a program interface of a designated program which is in use. The processing unit is configured for receiving a locking command of a locking application of the computer device, in order to keep the designated program being in use and the display unit displaying only the program interface, and for controlling the display unit to display only the locking interface when the designated program is not in use.

### BACKGROUND OF THE INVENTION

1. Field of the Invention

The present disclosure relates to a computer device and a locking method thereof; in particular, to a computer device capable of locking screen and the screen locking method thereof.

2. Description of Related Art

In using a computer device, a user might take protection measures, such as locking screen to prevent from unauthorized operation, to secure data in the computer device if the user needs to leave from the computer device for a while. However, some on-going tasks in the computer device may still have to be monitored when the data are protected. For example, status or progress of a file which is downloading or transferring needs to be observed at all time.

In the above-mentioned circumstances, none of known schemes are able to prevent unauthorized access to protected data as well as allow monitoring or operating data which are intended to be monitored. In other words, users can only choose one side from data security and operation convenience, which causes big problems and inconvenience in operating computer devices.

### SUMMARY OF THE INVENTION

The present disclosure provides a computer device capable of locking screen, including a display unit and a processing unit. The display unit is used for displaying one of a locking interface and a program interface of a designated program which is in use. The processing unit is configured for receiving a locking command of a locking application of the computer device, in order to keep the designated program being in use and the display unit displaying only the program interface, and for controlling the display unit to display only the locking interface when the designated program is not in use.

Additionally, the present disclosure provides a screen locking method for a computer device, including: receiving a locking command of a locking application of the computer device for keeping a designated program of the computer device being in use and a display unit of the computer device displaying only a program interface of the designated program; and controlling the display unit to display only a locking interface when the designated program is switched to be not in use.

Alternatively, the present disclosure provides a computer readable medium. The computer readable medium stores a set of code, wherein when the set of code is read by the processing unit, the processing unit executes steps in the above-mentioned method.

In summary, the computer device capable of locking screen and the screen locking method may lock the computer screen while display some designated program interface. Therefore, data need to be protected from unauthorized access in the computer device can be secured, as well as allowing users to continue monitoring or observing some information needs to be monitored. Hence the need of secure and effectiveness of using computer device are balanced, and the convenience of using computer device is also increased.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

FIG. 1 shows a block diagram of a computer device according to one embodiment of the present disclosure;

FIG. 2 shows a perspective view about screen interface of the computer device according to one embodiment of the present disclosure;

FIG. 3 shows a perspective view of a setting page of a locking application according to one embodiment of the present disclosure;

FIG. 4 shows a perspective view of displaying a program interface according to one embodiment of the present disclosure (displaying interface of an application program);

FIG. 5 shows a perspective view of selecting an indicated area according to one embodiment of the present disclosure;

FIG. 6 shows a perspective view of displaying a program interface according to one embodiment of the present disclosure (displaying the indicated area)

FIG. 7 shows a perspective view of displaying a program interface according to one embodiment of the present disclosure (displaying interface of screen desktop);

FIG. 8 shows a perspective view of displaying locking interface according to one embodiment of the present disclosure; and

FIG. 9 shows a flow diagram of screen locking method of a computer device according to one embodiment of instant disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

[Computer Device Embodiment]

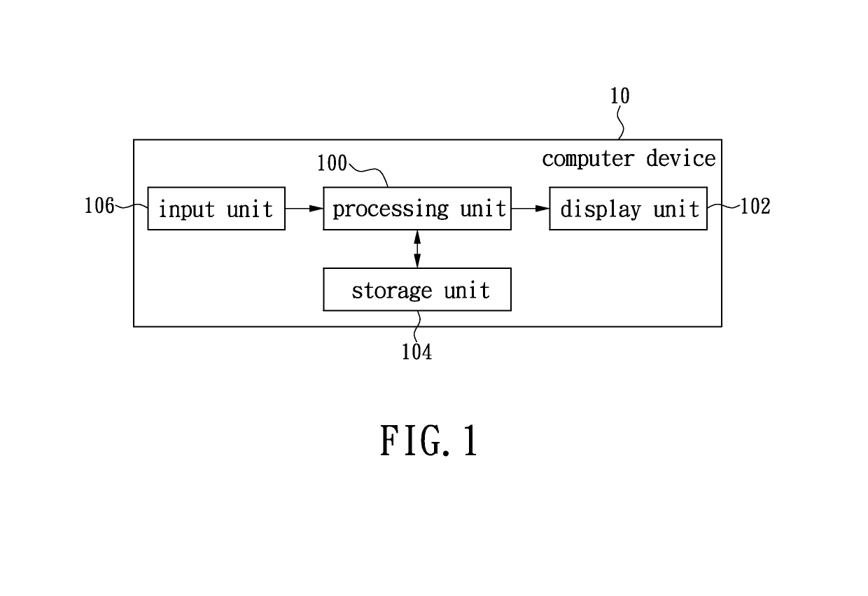

Referring to FIG. 1, FIG. 1 shows a block diagram of a computer device according to one embodiment of the present disclosure. The computer device 10 includes at least a processing unit 100 and a display unit 102 connected with each other. The computer device 10 may be a desktop computer, a laptop computer, a tablet, or a smart phone. The processing unit 100 may be a central processing unit (CPU), and the display unit 102 may be a liquid crystal display (LCD) or a touch display.

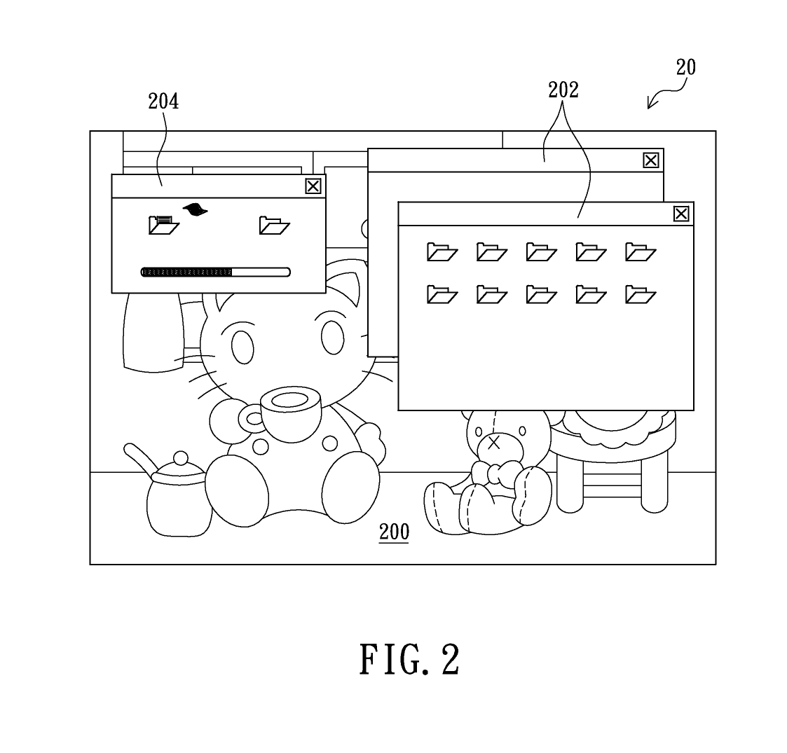

Please jointly refer to FIG. 2 which shows a perspective view of the scene shown on the display unit. When the computer device 10 is powered on and the operating system is loaded, the display unit 102 could display a user interface on a screen 20 of the display unit 102 based on control of the processing unit 100. The user interface may include a screen desktop 200 and one or more program interface of application programs 202 of the computer device 10 activated by a user. Besides, the screen desktop 200 may further include program interfaces of control programs 204 in the operating system performed by the processing unit 100 based on the user's operation. The control program 204 may exemplarily be configured to monitor transmission status and progress of a file, and to output a dialog box on the screen 20 to show such information.

When the user intends to prevent the program interface shown on the screen 20 of the display unit 102 from being read or the application program being operated as well as to keep controlling the progress or status of some specific programs, a locking application may be activated by the processing unit 100 to lock the screen and achieve the goal. Therefore, back to FIG. 1, the computer device 10 in the present embodiment may further include a storage unit 104 for storing program codes of the locking application, so that the processing unit 100 could read the program codes and perform functions of locking screen.

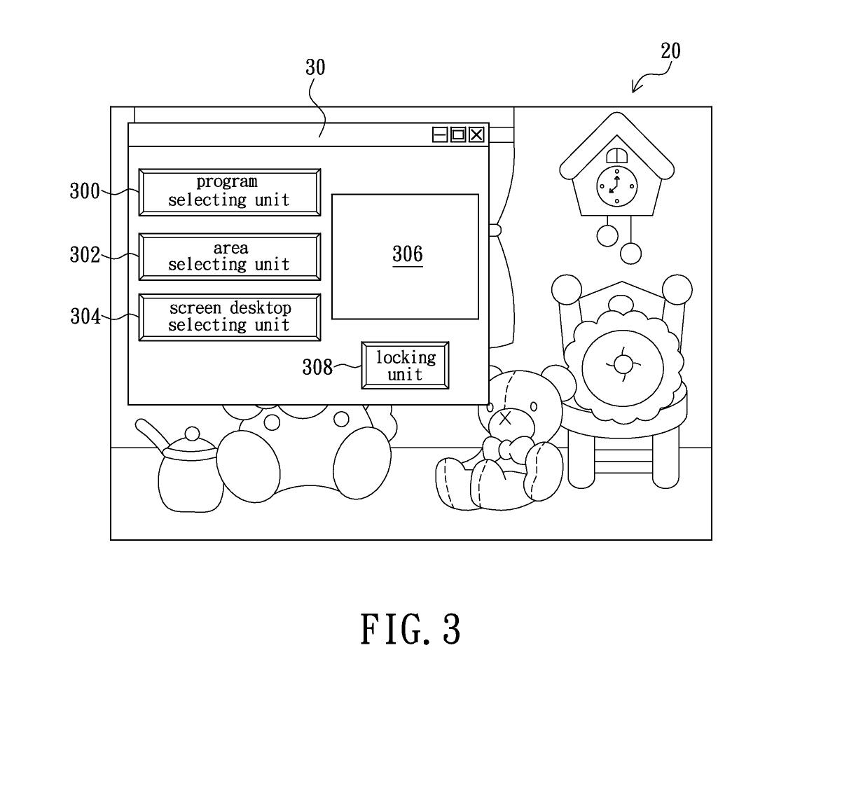

Please refer to FIG. 3, which shows a perspective view of the interface of the locking application on the display unit 102. The user may click/touch an icon (not shown in FIG. 3) on the screen 20 that refers to the locking application to inform the processing unit 100 to activate the locking application. When the locking application is activated, a setting page 30 could firstly be displayed on the screen 20 of the display unit 102 for setting preferences. In the present embodiment, the setting page 30 includes a program selecting unit 300, an area selecting unit 302, and a screen desktop selecting unit 304. Said selecting units may be laid out in the form of buttons for opening a selecting box or computer icons on the setting page 30.

The program selecting unit 300 is configured to select one of multiple application programs installed in the computer device 10 as a designated program by the user. The area selecting unit 302 is used to select an indicated area from the screen desktop 200 by the user, wherein the application program or the control program indicated in the indicated area is then identified as the designated program. The user may select a dialog shown on the screen desktop 200 via the area selecting unit 302, so that the control program corresponding the dialog is defined as the designated program. The screen desktop selecting unit 304 is used to define the functional command whose function is to display the screen desktop as the designated program. Refer to FIG. 1, the computer device 10 in the present embodiment may further include an input unit 106 to be operated by the user to select the designated program and input other input data. The input unit 106 may exemplarily be a keyboard, a mouse, or a touch panel of a touch display.

The setting page 30 may further include a locking unit 308. When the designated program is decided, the user could use the locking unit 308 to generate a locking command. The processing unit 100 receives the locking command and starts locking screen.

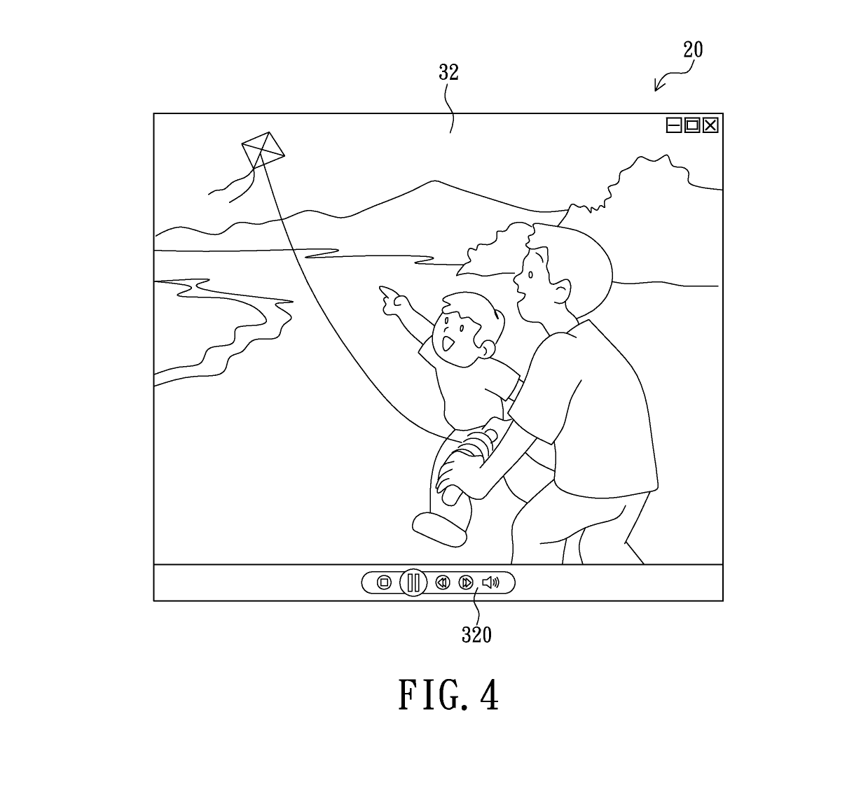

Please refer to FIG. 4 which depicts a perspective view of a program interface of one of the designated program. After the user chooses an application program as the designated program via the program selecting unit 300 and the processing unit 100 receives the locking command, the processing unit 100 may control the designated program to be in use, and cause the program interface 32 of the active designated program to be displayed in full screen on the top of the screen 20 of the display unit 102, so that the display unit 102 displays only the program interface 32. Various application programs may be installed in the computer device 10, such as document processing programs, slide show production programs, image viewing programs, media playing programs, or network browsing programs, and so on. The user could select any of the application programs by the program selecting unit 300 to be the designated program. When the program interface 32 of the designated program is displayed on the display unit 102, the processing unit 100 may allow the user to control or operate some of the functions of the designated program. For instance, as shown in FIG. 4, if the designated program is a media playing program (e.g. Windows Media® Player), the processing unit 100 could output the video clip played by the active media playing program to the display unit 102 in full screen. Thus, other computer icons or interfaces of other application programs shown on the screen 20 of the display unit 102 could be covered under the full-screen program interface and unable to be operated by the user. The processing unit 100 allows the user to operate control buttons 320 relating functions of playback, pause, fast forward, or volume adjustment, via keyboard or mouse, in order to adjust the playing of the movie clip. Therefore, the user could operate and browse the program interface of the designated program in a normal fashion, and keep data and other interfaces the user is not willing to be revealed away from other people at the same time.

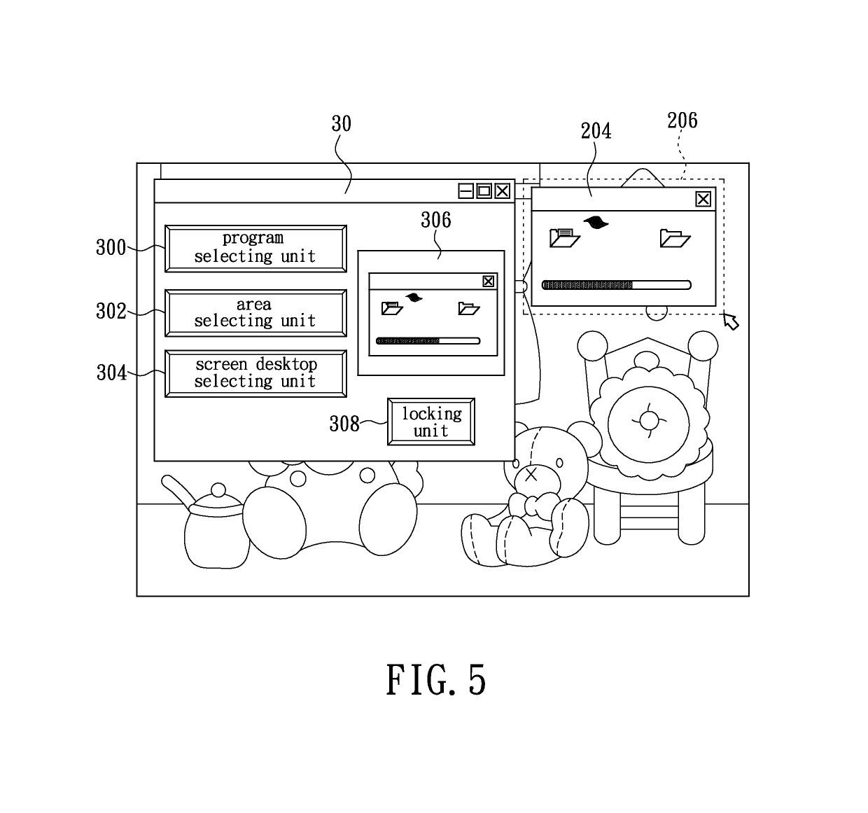

If the user intends to observe an item shown in a specific area on the screen desktop 200 when the screen is locked, the user may select on the screen desktop 200 via the area selecting unit 302 of the setting page 30. Please refer to the perspective view of selecting an indicated area on the screen as shown in FIG. 5. When the user tries to hide what are shown on the screen 20 except for the dialog box 204 for tracking the information shown on the dialog box 204, the area selecting unit 302 can be used to select the area. When the processing unit 100 determines the area selecting unit 302 is clicked, the processing unit 100 further determines the position and range of the indicated area 206 that the user selects from the screen desktop 200 by the input unit 106, and identifies the application program or the control program which interface is encircled in the indicated area 206. As shown in FIG. 5, it is a dialog box surrounded in the indicated area 206, generated by control programs of the computer device 10 corresponding to the user's operation to provide information for users. In the present embodiment, corresponding control program of said dialog box 204 is used to inform the progress of a file transmission.

The processing unit 100 may output the interface in the indicated area 206 to a preview area 306 of the setting page 30 for user confirmation. The processing unit 100 determines the control program corresponding to the interface displayed in the preview area 306 (the dialog box 04 in the present embodiment) is the designated program when the locking command is received.

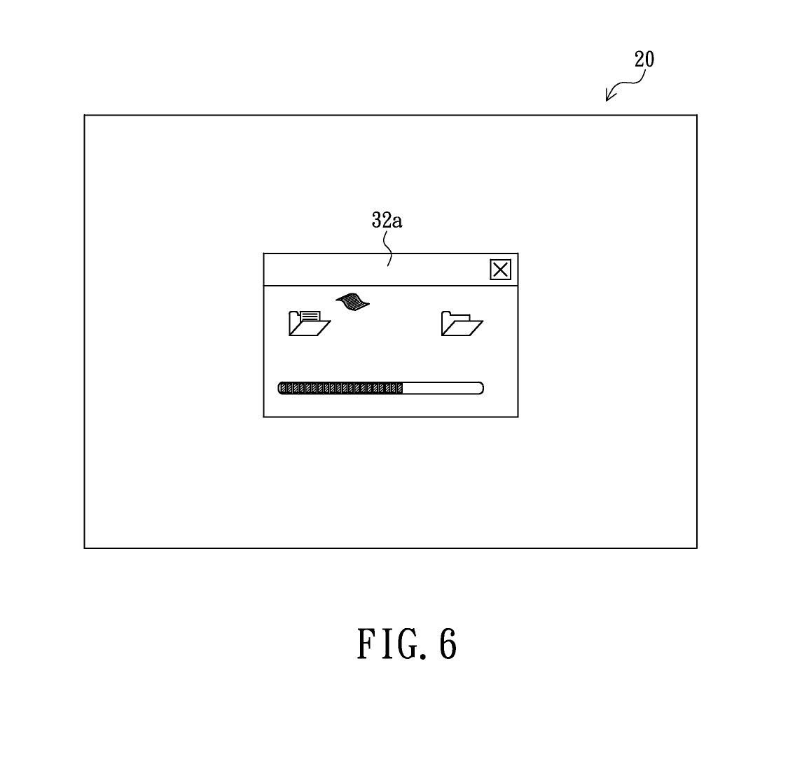

Please refer to FIG. 6 which depicts a perspective view of the program interface of a designated program. FIG. 6 shows the program interface of the control program based on the setting page 30 in FIG. 5. the processing unit 100 may output the program interface 32a of the designated control program on the top of the screen 20 of the display unit 102, which makes the display unit 102 display only the program interface 32a. If the program interface 32a is not displayed in a full-screen manner on the screen 20, the spare space of the screen 20 may remain empty. The program interface 32a of the present embodiment is the dialog box indicated from the screen desktop 200. Since the processing unit 100 could determine the corresponding control program of the encircled interface, when the program interface is displayed in the screen locking state, said program interface may still provide real time information according to the control program. For example, the program interface shown in the screen locking state could continuously update the progress of the file transmission instead of showing simply a static image on the display unit 102.

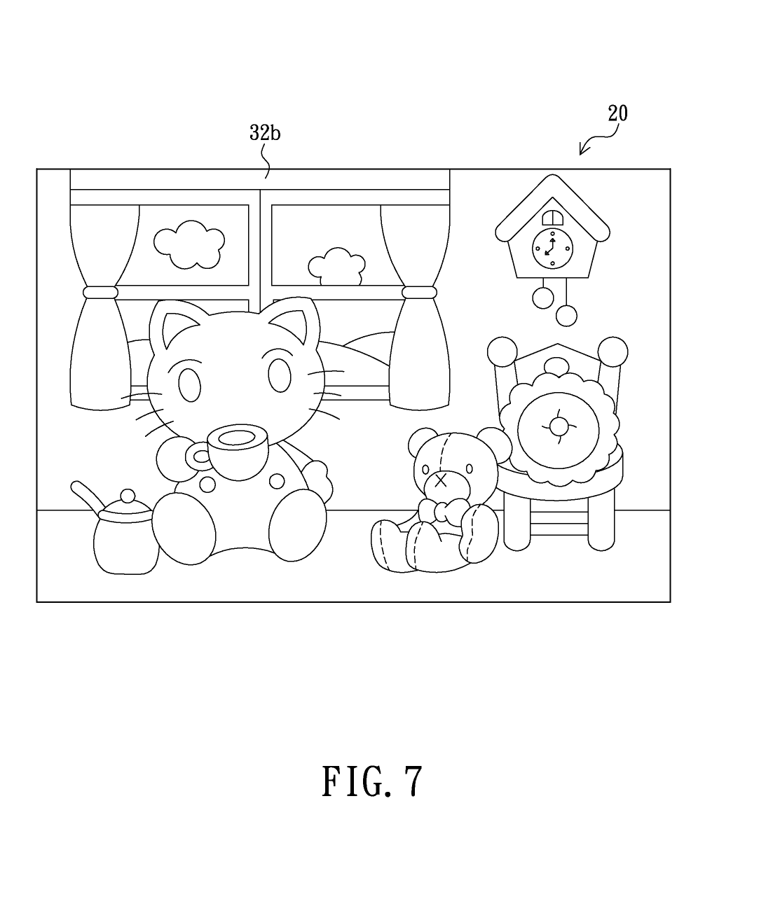

Back to FIG. 3, the user could also use the screen desktop selecting unit 304 to select the screen desktop 200 to be the program interface of the designated program. In addition to preview the image of the screen desktop 200 in the preview area 306, when receiving the locking command, the processing unit 100 would execute a functional command used to display the screen desktop (refer to FIG. 7), and output the image of the screen desktop 200 as the program interface 32b on the screen 20. The former mentioned functional command may be a specific default command built in the operating system of the computer device 10 that the processing unit 100 simply needs to set as the designated program and execute when the screen desktop selecting unit 304 shown in FIG. 3 is selected.

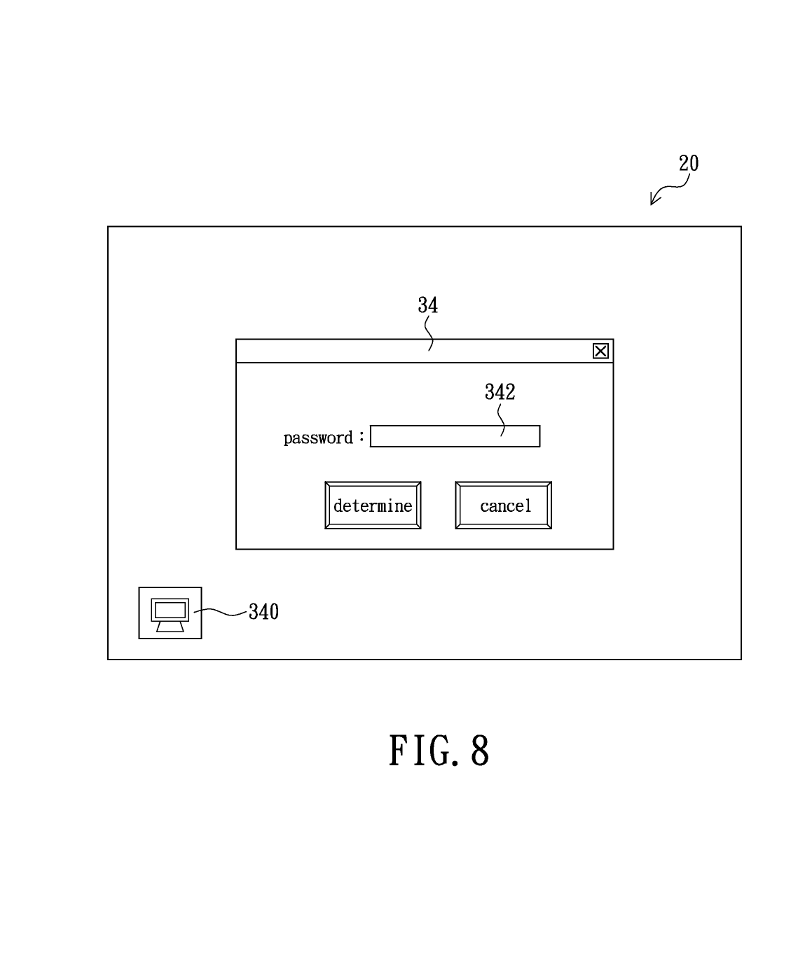

Next, please refer to FIG. 8. When the designated program is not in use, the processing unit 100 outputs a locking interface 34 to the display unit 102, so as to show only the locking interface 34 on the display unit 102. For instance, when the user switches the designated program whose program interface is displayed on the top of the screen 20 of the display unit 102 or tries to minimize the program interface, the processing unit 100 may, according to a received switch command (e.g. simultaneously press “Alt” and “Tab” keys on the keyboard) or a command generated by pressing the “minimization” icon, output the locking interface 34 as shown in FIG. 8 to the display unit 102 and prohibit operations to any application programs or icons other than the locking interface 34. The locking interface 34 may also displayed in the full-screen manner on the top of the display unit 102, and therefore covers other interfaces displayed before the screen is locked. Hence, even if the program interface of the designated program is minimized, other protected data and interfaces on the display unit 102 would still be invisible and secured. The locking interface 34 may be generated from a screen locking command built in the operating system of the computer device 10, which is executed by the processing unit 100, such as the default “lock the computer” command in Windows® operating system. The locking interface may alternatively be generated from the program codes of customized locking application by the processing unit 100.

When the designated program is minimized due to pressing the “minimization” icon, the locking interface 34 may correspondingly include a computer icon 340 representing the minimized designated program, which the user may click or tab on via input unit. When determining that the computer icon 340 is clicked or tabbed, the processing unit 100 re-displays the program interface of the designated program back to top of the display unit 102. Besides, if the program interface is switched to be covered by the locking interface 34 based on the switch command, the processing unit 100 may also re-display the program interface back to top of the display unit 102, as shown in FIG. 4, 6, or 7, when receives the switch command again.

Furthermore, the locking interface 34 may include an input area 342 for the user to input certification data in the input area 342 by the input unit 106, so as to close the locking interface 34 and re-display icons and data originally shown on the user interface of the screen 20. The processing unit 100 my compare preset certification data stored in the storage unit 104 with the certification data received from the input area 342 to certify whether the inputted certification data is identical to the preset certification data. When the certification data is confirmed to be correct, the processing unit 100 closes the full screen locking interface 34 and the program interface, and shows the setting page 30 of the locking application on the display unit 102 as shown in FIG. 3. In other possible embodiments, when the certification data is confirmed, the processing unit 100 may alternatively close the locking application and display icons and application programs for normal operations, as shown in FIG. 2.

In further, in order to ensure that the user could close the locking interface or the locking application via the certification data, the processing unit 100 may firstly determine whether the preset certification data exists in the computer device 10 when the locking command is received. When the preset certification data is already stored in the storage unit 104 of the computer device 10, the processing unit 100 may start to display the program interface of the designated program. On the other hand, if the preset certification data do not exist in the computer device 10, the processing unit 100 may require for a set of data as the preset certification data. For example, the processing unit 100 generates a password setting page for the user to enter a set of passwords and stores in the storage unit 104 for unlocking purpose. When the user inputs the certification data in the input area 342 of the locking interface 34 as shown in FIG. 8, the processing unit 100 may immediately compare the preset certification data with the received certification data to determine the data accuracy, and hence decide whether to close the locking interface or the locking application or not.

[Screen Locking Method of a Computer Device Embodiment]

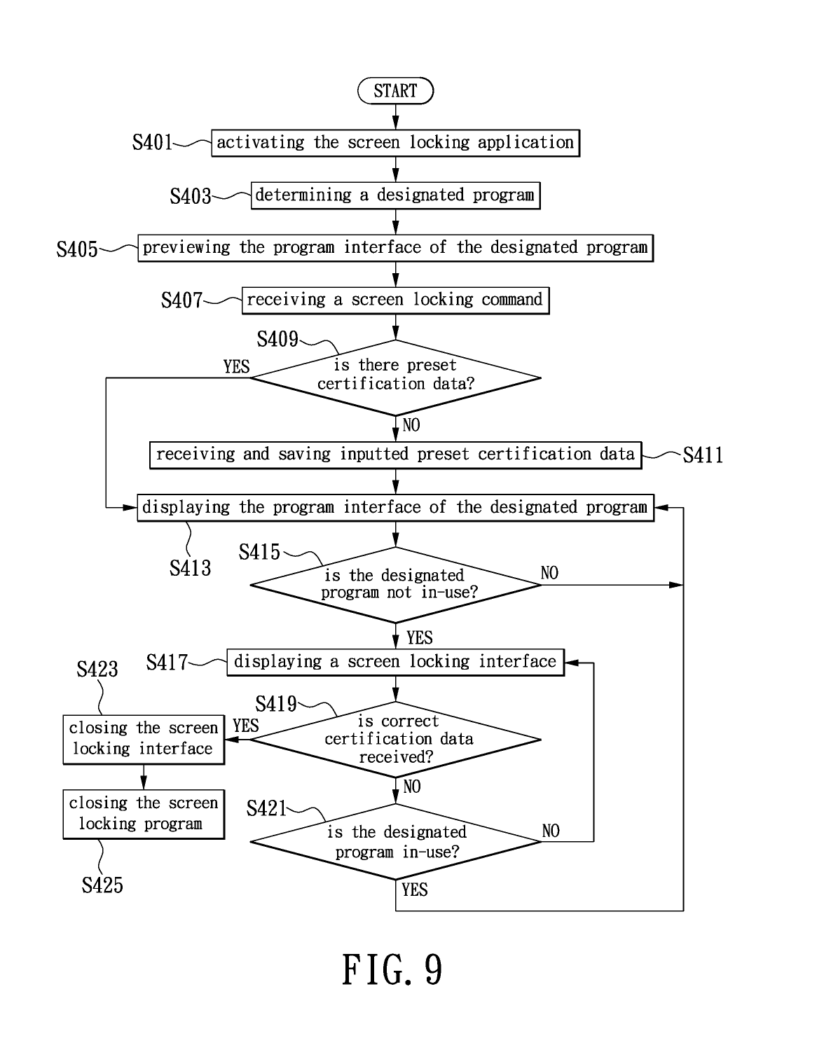

Please refer to FIG. 9 which depicts a flow chart of a screen locking method of a computer device according to another embodiment of the present disclosure. The method illustrated in FIG. 9 could be applied on the computer device shown in FIG. 1, and therefore please jointly refer to FIG. 1 for explanation.

The processing unit 100 of the computer device 10 may activate a locking application in light of a command from a user (S401), and then output a setting page 30 on a screen 20 of the display unit 102 as shown in FIG. 3 according to program codes of the locking application. The processing unit 100 identifies a designated program via an application program, a control program, or functional command which is selected via the setting page 30 by the user (S403), and outputs the program interface of the designated program to a preview area 306 of the setting page 30 for the user (S405). Approaches of selecting the designated program via the program selecting unit 300, area selecting unit 302, and screen desktop selecting unit 304 of the setting page 30 have already been described with various examples in the formal embodiment. Please refer descriptions related to FIGS. 4 to 7 for the details.

Following, when the processing unit 100 receives the locking command (S407), the processing unit 100 may determine whether the storage unit 104 of the computer device 10 stores preset certification data configured to unlock the screen (S409). When the processing unit 100 determines that the computer device 10 does not store the preset certification data, the processing unit 100 may require for a set of passwords to be the preset certification data (S411). Otherwise, when the processing unit 100 determines that the preset certification data exists in the computer device 10 (“Yes” for step S409) or the preset certification data is received from the user after step S411, the processing unit 100 may cause the designated program to be in-use and display the program interface on the screen 20 of the display unit 102 as shown in FIG. 4, 6, OR 7 (S413). The program interface may be displayed on the top of the screen 20 in full-screen manner which covers all the other icons or interfaces other than the program interface.

During displaying the program interface, the processing unit 100 may continuously determine whether the designated program is changed to be not in use (S415), such as switching the designated program or the program interface been minimized by the user, which makes the program interface no longer display on the top of the screen 20 of the display unit 102. If the designated program is not switched from in-use to be not in-use (“No” for step S415), the program interface of the designated program may keep being displayed on top of the screen 20 (returning back to step S413). On the other hand, when the processing unit 100 determines that the designated program is not in use (“Yes” for step S415), the processing unit 100 outputs the locking interface 34 as shown in FIG. 8 to the top of the screen 20 (S417), preventing any image, icons, or interface on the screen desktop from been peeked.

The locking interface 34 includes an input area 342 used for inputting certification data, in which the processing unit 100 may receive and determine whether the certification data is correct when the locking interface 34 is displayed (S419). When the processing unit 101 does not receive the certification data for unlocking the screen or the received certification data is incorrect, the processing unit 100 continues to determine whether the designated program is switched back to be in use (S421). For example, the user may utilize the input unit 106 to switch the program interface back to the top of the screen 20 or click/tab on the computer icon 340 on the locking interface 34 to re-display the program interface back to the top of the screen 20. If the designated program is not changed to be in use, the processing unit 100 may keep the locking interface 34 displaying on the top of the screen 20 (returning to step S417). If the designated program is changed to be in use again, the processing unit 100 may then re-display the program interface of the designated program back to the top of the screen 20 (returning to step S413).

On the other hand, when the processing unit 100 receives correct certification data (“Yes” for step S419), the locking interface 34 may be closed (S423), in order to show the screen desktop 200 and the setting page 30 of the locking application as shown in FIG. 3. The processing unit 100 may further close the locking application (S425) to display what are originally shown on the screen 20, as exemplarily depicted in FIG. 2. To determine whether the certification data is correct, the processing unit 100 may, for example, compares the received certification data with the preset certification data to confirm the correctness.

In particularly speaking, the above-mentioned step S405 about previewing the program interface of the designated program, and steps S409 to S411 about determining and setting the preset certification data are not the inevitable steps and could be omitted in the embodiment. The steps of S423 to S425 may also be modified to take only one of the two in practice.

[Possible Effects of the Embodiments]

According to the embodiments of the present disclosure, the computer device and the screen locking method are able to prevent information revealed on the screen being peeked or activated applications being operated without authorization, and therefore secure data in the computer device.

Besides, according to the embodiments of the present disclosure, in the screen locking state, the user can still access and operate designated programs, and observe the program interface on the screen. Thus, as the data are secured, using the computer device conveniently is also allowed.

Furthermore, according to various way of deciding the designated program as described in the embodiments of the present disclosure, users can operate the selected application program or monitor the status or progress of selected tasks under the screen locking state. The varieties of operating requirements are highly fulfilled.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A computer device capable of locking screen, comprising:
a display unit, used for displaying one of a locking interface and a program interface of a designated program which is in use; and
a processing unit, used for receiving a locking command of a locking application of the computer device to keep the designated program being in use and the display unit displaying only the program interface, and for controlling the display unit to display only the locking interface when the designated program is not in use.

2. The computer device according to claim 1, wherein the locking interface includes an input area for receiving a certification data, wherein the locking interface is closed when the processing unit determines the certification data is correct.

3. The computer device according to claim 1, wherein the locking interface includes an input area for receiving a certification data, wherein the locking application is closed when the processing unit determines the certification data is correct.

4. The computer device according to claim 1, wherein the designated program is one of multiple application programs of the computer device or one of multiple control programs of the computer device.

5. The computer device according to claim 1, wherein the designated program is determined to be not in use when the program interface is minimized.

6. The computer device according to claim 5, wherein when the program interface is minimized the locking interface includes an icon representing the designated program, which is used for re-displaying the program interface of the designated program back to the display unit.

7. The computer device according to claim 1, wherein the locking application provides a setting page to be displayed on the display unit, wherein the setting page includes a program selecting unit for selecting one of multiple application programs of the computer device, an area selecting unit for selecting an indicated area on a screen desktop of the computer device, and a screen desktop selecting unit for selecting the screen desktop, wherein the designated program is the selected one of the multiple application programs, a controlling program shown in the indicated area, or the selected screen desktop.

8. The computer device according to claim 7, wherein the setting page further includes a preview area, used to display the program interface of the designated program determined by the program selecting unit, the area selecting unit, or the screen desktop selecting unit.

9. The computer device according to claim 7, wherein the setting page further includes a locking unit for generating the locking command according to operation of a user.

10. A screen locking method for a computer device, comprising:
receiving a locking command of a locking application of the computer device for keeping a designated program of the computer device being in use and a display unit of the computer device displaying only a program interface of the designated program; and
controlling the display unit to display only a locking interface when the designated program is switched to be not in use.

11. The method according to claim 10, before receiving the locking command, further comprising:
activating the locking application in order to display a setting page on the display unit;
determining the designated program from one of a program selecting unit, an area selecting unit, and a screen desktop selecting unit in the setting page; and
displaying the program interface in receiving the locking command from a locking unit in the setting page;
wherein the program selecting unit is used for selecting one of multiple application programs of the computer device, the area selecting unit is used for selecting an indicated area on a screen desktop of the computer device, and the screen desktop selecting unit is used for selecting the screen desktop;
wherein the designated program is the selected one of the multiple application programs, a controlling program shown in the indicated area, or the selected screen desktop.

12. The method according to claim 11, after determining the designated program from the setting page, further comprising:
displaying the program interface of the designated program in a preview area of the setting page.

13. The method according to claim 10, after the display unit displaying only the locking interface, further comprising:
receiving a certification data;
determining whether the certification data is correct; and
closing the locking interface or closing the locking application when the certification data is determined to be correct.

14. The method according to claim 12, after receiving the locking command, further comprising:
determining whether a preset certification data exists;
requiring for the preset certification data for storing when the preset certification data does not exist; and
allowing to display the program interface when the preset certification data is determined to exist;
wherein the preset certification data is used for certifying the certification data.

15. The method according to claim 10, after the display unit displaying only the locking interface, further comprising:
displaying an icon representing the designated program on the locking interface;
wherein the icon is used for re-displaying the program interface on the display unit.

16. A computer readable storage medium, storing a set of code, wherein when the set of code is read by a processing unit, the processing unit performs the method according to claim 1.
